(19) United States
(12) Patent Application Publication
(10) Pub. No.: US 2008/0053834 A1
(43) Pub. Date: Mar. 6, 2008

(54) Electroless plating method for resin surfaces

(75) Inventor: Rikiya Shimizu, Kawagoe-shi (JP)

Correspondence Address: John J. Piskorksi;Rohm and Haas Electronic Materials LLC, 455 Forest Street, Marlborough, MA, 01752, US

(73) Assignee: Rohm and Haas Electronic Materials LLC, Marlborough, MA (US)

(21) Appl. No.: 11/810,876

(22) Filed: Jun. 7, 2007

(30) Foreign Application Priority Data
Sep. 6, 2006 (JP) 2006-161415

(51) Int. Cl. H05F 3/00

(52) U.S. Cl. 205/261; 205/164

(57) ABSTRACT

A plated film having superior uniformity and adhesiveness is provided without requiring a surface roughening process of the resin by a permanganate treatment and a tin-containing catalyst adhering treatment. The material to be plated is treated by a pre-treatment solution including anionic surfactant, organic solvent, and alkaline components, then treated by a solution including anionic surfactant and precious metal ions, and plated by electroless plating.

The present invention relates to a method for forming a metal plated film by metal plating the surface of the material to be plated such as a material having low conductivity or an object having a mirror surface, particularly, a resin material.

Electroless plating is well known as a method for providing a metallic film on the surface of a material having low conductivity such as a resin material. Electroless plating, a method for forming a metallic film on the surface of the material to be plated by chemically depositing metal ions in the solution, is different from electrolytic plating that makes electrodeposits, and does not require conductivity on the surface of the material to be plated. Therefore, this process is applied in a wide range of fields such as decorations and electronic devices. In the field of electronic devices, various plastic materials such as polyimide resin are used as the base materials for printed-circuit boards, flexible printed-circuit boards, and tape automatic bonding mounting substrate. Electroless plating method is used for their metallization. Even in this field, uniform forming of the plating film on the surface of the material to be plated is sought, and swelling and peeling of the plated film are not desirable.

However, the problem of a plated film formed by electroless plating is insufficient adhesion to the resin material. The weak adhesion between the resin surface and plated film causes the swelling and peeling of the plated film. Therefore, various methods for treating the surface of the material to be plated prior to the electroless plating, for example, a method that chemically etches the resin surface to roughen the surface, have been proposed. Ordinary etching is insufficient for polyimide resin. A proposed method performs electroless plating after pre-etching that makes the resin surface swell by immersion in a special solution before etching and with a chromic acid and sulfuric acid mixture as disclosed in unexamined Japanese Patent Publication No. H5-112872. Also, a electroless plating method that includes a catalyst seeding process after a process for treating with an aqueous solution containing hydrazine hydrate and alkali metal hydroxide is proposed as disclosed in unexamined Japanese Patent Publication No. H5-90737.

Another proposed method is an electroless plating method that includes a catalyst seeding process after a process for treating with a solution that contains at least one of an anionic surfactant and a nonionic surfactant, and alkali components as disclosed in unexamined Japanese Patent Publication No. 2002-275638.

Of the above methods, the former improves the adhesiveness of the plated film by the anchoring effect caused by the roughening of the surface of the material to be plated. However, in the field of electronic devices and electrical circuits, the thinning of conductor circuits and the roughening of the surface of the material to be plated cause a deterioration of the characteristics of the conductor circuit. To improve the characteristics of the conductor circuit, the surface smoothness of the material to be plated must be improved. In addition, it is necessary to consider environmental pollution because deadly poisonous materials such as chromic acid are used in the etching used for surface roughening.

The technology described in Japanese patent Publication No. 2002-275638 proposes a method that does not carry out surface roughening of the material to be plated and forms a plated film having superior adhesiveness. However, the disclosed method uses a conventionally used colloidal catalyst mixture of tin and palladium in the catalyst seeding process. This tin-palladium colloidal catalyst features easy adhesion to various bases, but the entire process lengthens and the control becomes complicated because a pretreatment bath is necessary to maintain colloidal state and activation treatment with an acidic solution after the catalyst seeding. A problem is waste treatment because highly toxic tin is used.

The objective of the present invention is to provide a new electroless plating method that does not use tin, that presents a problem to the environment, and can form a plated film having superior uniformity and adhesiveness even for base materials such as material to be plated that cannot obtain good adhesiveness with a conventional electroless plating method, particularly, polyimide resin which has difficulty obtaining a plated film with good uniformity and adhesiveness.

As a result of diligent studies to solve the above problems, the present inventors discovered for the present invention how to obtain a plated film that is uniform and has excellent adhesiveness to the material to be plated, particularly the surface of polyimide resin, by carrying out electroless plating after the surface of the material to be plated was subjected to a special pre-treatment and the catalyst was seeded with a special solution.

The present invention is an electroless plating method comprising a process for pre-treating the material to be plated with a solution including anionic surfactant and organic solvent, a process for treating with a treatment solution containing precious metal ions which does not essentially contain tin ions and is a solution containing anionic surfactant and precious metal ions to attach the precious metal to the surface of the material to be plated, a process of heating and drying the plated material, a process of treating with an aqueous alkaline solution, and followed by a process of electroless plating. A second embodiment of the present invention is a method for forming metal plating comprising processes of pre-treating the material to be plated with a solution containing anionic surfactant, organic solvent, and alkaline components; treating with a treatment solution containing precious metal ions which essentially does not contain tin ions and is a solution including anionic surfactant and precious metal ions to attach the precious metal to the surface of the material to be plated; heating and drying the material to be plated; treating with an aqueous alkali solution; electroless plating; followed by electrolytic plating.

According to the present invention, a plated film with excellent adhesiveness can be formed by using a relatively safe treatment solution and not using a highly poisonous treatment solution such as chromic acid to perform the treatment. A plated film having excellent adhesiveness can be deposited even on a relatively smooth surface without the need for roughening the surface of the material to be plated by, for example, chromic acid or permanganate treatment. Furthermore, a uniform plated film with excellent adhesiveness can be formed on the material to be plated on which depositing a uniform plated film was difficult by a conventional method for polyimide resin. In addition, compared to a conventional electroless plating method, the control becomes simple because a catalyst solution requiring complex control does not have to be used, and the entire treatment process can be shortened. This plating method produces little environmental pollution such as wastewater because toxic metal components such as tin are not contained.

The electroless plating method of the present invention first treats the surface of the material to be plated with a pre-treatment solution that contains anionic surfactant, organic solvent, and, when needed, alkaline components.

The above anionic surfactant can be carboxylates; sulfonates such as alkylbenzene sulfonate; alkyl sulfates such as sodium lauryl sulfate, potassium lauryl sulfate, sodium stearyl sulfate, potassium stearyl sulfate, polyoxyethylene alkyl ether sulfate; and phosphoric esters such as polyethylene glycol mono octylphenyl ether phosphate. In particular, phosphoric esters such as polyethylene glycol mono-octylphenyl ether phosphate and benzenesulfonate are preferred. The anionic surfactant may be used individually or as a mixture. The concentration of the surfactant in the pre-treatment solution can be in the range from 2 to 35 g/L, preferably, in the range from 4 to 12 g/L.

For the above mentioned organic solvents, a solvent that swells the surface of the material to be plated, for example, resin, is acceptable and the above-mentioned organic solvents are alcohols such as methanol, ethanol, 1-propanol, 2-propanol, butanol, 2-aminoethanol, 1-amino-2-propanol, 2-amino-1-butanol; glycols such as ethylene glycol, propylene glycol, diethylene glycol; ethylene glycol mono-alkyl ethers; diethylene glycol mono-alkyl ethers; ketones such as acetone; esters such as acetic acid ethyl ester, butyl acetate; or mixtures thereof. The organic solvent clearly differs from the above-mentioned anionic surfactant in not having an anion exchange group. The concentration of the organic solvent in the pre-treatment solution can be in the range from 1 to 100 g/L, preferably in the range from 5 to 50 g/L, more preferably in the range from 10 to 30 g/L.

The pre-treatment solution of the present invention is alkaline. The pre-treatment solution may contain alkaline components. The above-mentioned alkaline components may be compounds that exhibit alkalinity in the solution, and are, for example, hydroxides, carbonates, and phosphates. Potassium hydroxide, sodium hydroxide, or lithium hydroxide are preferred. The concentration of the alkaline components in the pre-treatment solution can be in the range from 20 to 80 g/L, preferably in the range from 25 to 50 g/L, and more preferably in the range from 30 to 40 g/L.

The pre-treatment solution is prepared by dissolving the above-mentioned components in water. The water is preferably tap water or deionized water, and may contain organic solvents which do not act to swell the surface of the material to be plated. The pH of the pre-treatment solution is preferably 12 or higher.

The treatment method of the pre-treatment solution has no particular restrictions and may be a method capable of producing sufficient contact of the surface of the material to be plated with the pre-treatment solution. For example, a method such as spraying is acceptable, and a method that immerses the material to be plated in the solution is preferred. The temperature of the pre-treatment solution is preferably from 50° C. to 80° C., and particularly 60° C. to 75° C. is preferred. The contact time of the material to be plated with the pre-treatment solution is not particularly limited, but is preferably from 5 minutes to 20 minutes. If the temperature of the pre-treatment solution is increased, the contact time of the material to be plated with the pre-treatment solution can be shortened. A temperature of 70° C. and contact for 10 minutes are particularly preferred.

To attach the precious metal to the surface of the material to be plated that was treated by the pre-treatment solution, an aqueous solution containing anionic surfactant, precious metal ions, and when needed acidic components and organic solvent is preferably used. Tin or the ions thereof are not essentially contained in the solution containing precious metal ions.

The anionic surfactant contained in the above-mentioned solution containing precious metal ions that is used in the process for attaching the precious metal to the surface of the material to be plated can be selected from the solutions listed for the pre-treatment solution. The same or a different surfactant as the one used in the pre-treatment solution may be used, but preferably, the pre-treatment solution and the solution containing precious metal ions use the same anionic surfactant. The concentration of the anionic surfactant in the solution containing precious metal ions can be in the range from 2 to 35 g/L, preferably, in the range from 5 to 12 g/L.

The above-mentioned precious metal ions can be well-known catalysts for electroless plating such as palladium, silver, and ruthenium. The ions of colloidal catalysts such as the well-known palladium-tin colloid are not included in the above precious metal ions. The precious metal ions are supplied by adding precious metal salts such as palladium chloride to the solution. The concentration of the precious metal ions as the salt in the solution can be in the range from 0.01 to 2 g/L, preferably in the range from 0.1 to 1 g/L.

The solvent for dissolving the precious metal ions and the anionic surfactant can be a polar solvent, but water is preferred. In some case, a solvent mixture of organic solvent and water is possible. The organic solvent can be suitably selected from the solvents used in the above pre-treatment solution. The same or a different solvent used in the pre-treatment solution can be used, but preferably the pre-treatment solution and the solution containing precious metal ions are the same organic solvent. When a solvent mixture of organic solvent and water in the solution containing precious metal ions is used, the concentration of the organic solvent can be in the range from 1 to 100 g/L, preferably in the range from 5 to 50 g/L, more preferably in the range from 10 to 30 g/L.

Acidic components can be added to the solution containing precious metal ions. The acid can be hydrochloric acid, sulfuric acid, or nitric acid, preferably hydrochloric acid. The hydrochloric acid can be added in the range from 0.3 to 13 g/L, preferably in the range from 0.6 to 6 g/L. The treatment solution containing precious metal ions is adjusted to be acidic, that is, in the pH range from 0 to 7.

To attach the precious metal to the surface of the pre-treated material to be plated, the temperature of the above solution is preferably from 50° C. to 80° C., and in particularly, that from 60° C. to 75° C. is preferred. The contact time between the material to be plated and the solution is not particularly limited, but is preferably from 5 minutes to 20 minutes. When the temperature of the solution is increased, the contact time between the material to be plated and the pre-treatment solution can be shortened. The temperature of 70° C. and a contact time of 10 minutes are particularly preferred. The treatment method of the solution containing precious metal ions is not particularly restricted and can be a method that produces sufficient contact of the surface of the material to be plated with the solution containing precious metal ions. For example, a method such as spraying is acceptable, but preferably the material to be plated is immersed in the solution.

The method of the present invention includes a process for heating and drying the material to be plated before carrying out the electroless plating after the process for adhering the precious metal to the surface of the material to be plated. In this case, the temperature is preferably from 50° C. to 150° C., in particular, from 100° C. to 120° C. is preferred. The heating and drying time is not particularly limited, but is preferably a duration from 10 minutes to 60 minutes.

Next, the method of the present invention includes a process for treating the surface of the material to be plated with an aqueous alkaline solution before carrying out the electroless plating performed after the process for attaching the precious metal to the surface of the material to be plated. In this case, the aqueous alkaline solution can be an aqueous solution of hydroxides, carbonates, or phosphates. Aqueous solutions of potassium hydroxide, sodium hydroxide, or lithium hydroxide are preferred. The concentration of the alkaline components in the aqueous solution is in the range from 10 to 70 g/L when it is converted to that of the salt, preferably in the range from 20 to 50 g/L. The temperature of the aqueous alkaline solution is not particularly limited but is preferably in the range from room temperature to 50° C. The contact time of the material to be plated with the aqueous alkali solution is adequate from 30 seconds to 2 minutes. Although the theory is not clearly understood, by carrying out the aqueous alkali solution treatment, a plated film having excellent uniform deposition of the plated film and adhesiveness to the surface of the material to be plated can be deposited.

Furthermore, the method of the present invention carries out the electroless plating after the above treatment is carried out and the precious metal is attached to the surface of the material to be plated. The electroless plating solution can be the one used conventionally. The precious metal can be deposited from a well-known electroless plating nickel plating solution or electroless copper plating solution. The conventional electroless plating conditions can be applied. Following the electroless plating, a thicker plated film can be obtained by an electroless plating process or electrolytic plating process.

In the present invention, a process for washing the surface of the material to be plated with water may be included between the processes described above.

The plated film can be deposited on various materials to be plated by the electroless plating of the present invention. In particular, the plated film can be formed on a resin base such as polyimide resin or polyamide resin.

### WORKING EXAMPLE 1

The material to be plated was a polyimide film (dimensions: 5 cm×10 cm) having thermoformability manufactured by Toray Dupont Co., Ltd.

Sodium hydroxide (34.5 g), diethylene glycol mono-butyl ether (23.875 g), and polyethylene glycol mono octylphenyl ether phosphate (8.305 g) were dissolved in water, and 1 liter of the pre-treatment solution was prepared. The above material to be plated was immersed for 10 minutes in the pre-treatment solution that had been heated to 70° C.

The material to be plated was removed from the pre-treatment solution, the surface thereof washed in water for 3 minutes at room temperature, and then immersed for 10 minutes in a 1-liter solution containing precious metal ions of palladium chloride (0.168 g), polyethylene glycol mono-octylphenyl ether phosphate (8.305 g), diethylene glycol mono-butyl ether (23.875 g), and hydrochloric acid (87.5 g) dissolved in water. The solution was heated to 70° C. This causes palladium to attach to the surface of the material to be plated.

The material to be plated with the attached palladium washed in water for 2 minutes at room temperature and washed for 1 minute with deionized water at room temperature. Next, the material to be plated was heated and dried for 30 minutes at 120° C., and after washing the surface with water, immersed for 1 minute at room temperature in an aqueous solution of sodium hydroxide (34.5 g/L).

Then after washing with water, the material to be plated was processed by electroless plating by using the well-known NIPOSIT (trademark) 468 electroless nickel plating solution (manufactured by Rohm and Haas Electronic Materials). The appearance of the obtained plated nickel film was checked visually for uniformity and the presence of swelling. The deposited plated nickel film had a uniform thickness of about 0.2 μm and no swelling.

### Peeling Test

The adhesion of the plated nickel film obtained in Working Example 1 was checked by the following method.

After attaching Cellotape® CT18 manufactured by Nichiban onto the surface of the deposited plated nickel film surface by applying sufficient pressure, the Cellotape® was quickly peeled off. The peeling characteristic of the plated nickel film was evaluated based on whether the Cellotape® and the plated nickel film did not get peeled off and remained on the surface of the material to be plated, or the Cellotape® and the plated nickel film peeled off and did not remain on the surface of the material to be plated.

### Adhesion Test

The plated material obtained in Working Example 1 was heated, dried, and the surface thereof was acid washed, and then plated by electrolytic sulfuric acid-copper plating. The electrolytic copper plating solution was the well-known Electrodeposit (trademark) 1100 electrolytic copper plating (manufactured by Rohm and Haas Electronic Materials). The obtained plated copper film had a thickness of 18 μm, and swelling was not seen in the film. The plated copper film was cut to a 1-cm width, and the adhesive strength was measured with a tester by raising at the speed of 50 mm/min at the angle of 90° C. conforming to the JIS C5012 printed-circuit board testing method. The result was an adhesion strength of 0.196 N/mm (0.20 kgf/cm).

### WORKING EXAMPLES 2 TO 4

Except for cases in which pre-treatment solutions containing the anionic surfactants listed in Table 1 were used in place of the polyethylene glycol mono octylphenyl ether phosphate used in the pre-treatment solution of Working Example 1, the peeling and adhesion tests were carried out by applying the method described in Working Example 1. Table 2 lists the results.

| | Anionic surfactant and amount added |
|---|---|
| Working example 2 | Sodium 2,4-dimethyl benzene sulfonate 6 g/L |
| Working example 3 | Sodium aklylbenzene sulfonate 6 g/L |
| Working example 4 | Sodium 2,4-dimethyl benzene sulfonate 3 g/L |
| | sodium alkylbenzene sulfonate 3 g/L |

### COMPARATIVE EXAMPLE 1

The same treatment as in Working Example 1 was carried out without performing the heating and drying treatments and the aqueous alkali solution treatment after the treatment with the solution containing precious metal ions. Table 2 shows the results.

### COMPARATIVE EXAMPLE 2

The same treatment as in Working Example 1 was carried out without carrying out the treatment with the aqueous alkali solution after the treatment with the solution containing precious metal ions. Table 2 shows the results.

### COMPARATIVE EXAMPLE 3

The same treatment as in Working Example 1 was carried out except for using a polycarbonate sheet as the material to be plated. However, the surface thereof could not be swollen by the pre-treatment solution.

TABLE 2

| | Uniformity | | | |
|---|---|---|---|---|
| | of | | | Adhesiveness |
| | deposition | Swelling | Peeling | N/mm (Kgf/cm) |
| Working | Better | No | No peeling | 0.196 (0.20) |
| Example 1 | | | | |
| Working | Better | No | No peeling | 0.147 (0.15) |
| Example 2 | | | | |
| Working | Better | No | No peeling | 0.137 (0.14) |
| Example 3 | | | | |
| Working | Better | No | No peeling | 0.157 (0.16) |
| Example 4 | | | | |
| Comparative | Good | No | Peeling | Not measured |
| Example 1 | | | | |
| Comparative | Good | No | Peeling | Not measured |
| Example 2 | | | | |

From the above results, it can be seen that by the method of the present invention the formation of a plated film having uniformity and good adhesiveness can be obtained.

A plated film having uniformity and good adhesiveness was formed on a smooth resin surface without the conventional roughening of the surface of the resin and without using a catalytic solution containing a colloidal catalyst such as tin. It can be understood that anionic surfactant must be contained in the solution that provides the catalytic noncolloidal precious metal.

What is claimed is:

1. An electroless plating method comprising:
a) treating a surface of a material to be plated with a solution comprising an anionic surfactant and an organic solvent;
b) treating the material with a metal ion solution containing precious metal ions and anionic surfactants, the metal ion solution is essentially free of tin ions;
c) heat treating the material to be plated;
d) treating the material to be plated with an aqueous alkaline solution; and
e) plating the material with a metal by electroless plating.

2. The method of claim 1, wherein the metal ion solution is acidic.

3. The method of claim 1, wherein the metal ion solution is not a colloidal solution.

4. The method of claim 1, wherein the anionic surfactant in the solution and the metal ion solution are the same.

5. The method of claim 1, further comprising washing the material with water between the method steps.

6. The method of claim 1, wherein the material to be plated in comprised of polyimide resin.

7. An electroless plating method comprising:
a) treating a surface of a material comprising polyimide resin with a solution comprising an anionic surfactant, and organic solvent and an alkali component;
b) treating the material comprising the polyimide resin with a metal ion solution containing precious metal ions and anionic surfactants, the metal ion solution is essentially free of tin ions;
c) heat treating the material comprising the polyimide resin;
d) treating the material comprising the polyimide resin with an aqueous alkali solution; and
e) plating the material comprising the polyimide resin with a metal by electroless plating.

8. The method of claim 7, further comprising the step of washing the material comprising the polyimide resin with water after each step of the method.

9. The method of claim 7, further comprising electrolytically depositing a metal on the metal electrolessly plated.
